(19) United States
(12) Patent Application Publication
(10) Pub. No.: US 2013/0185547 A1
(43) Pub. Date: Jul. 18, 2013

(54) SIGNAL RESET CIRCUIT FOR WIRELESS COMMUNICATION SYSTEMS

(71) Applicants: Rick Sturdivant, Placentia, CA (US); Joaquin Felipe Brown, Culver City, CA (US); Chris Turner, Orange, CA (US)

(72) Inventors: Rick Sturdivant, Placentia, CA (US); Joaquin Felipe Brown, Culver City, CA (US); Chris Turner, Orange, CA (US)

(21) Appl. No.: 13/349,561

(22) Filed: Jan. 13, 2012

(51) Int. Cl. G06F 9/06

(52) U.S. Cl. 713/1

(57) ABSTRACT

A wireless network reset system is disclosed. The system couples or connects to a power supply line. A microcontroller software module senses a signal from a Wi-Fi module that indicates a halting of a processor function. A reset module executes a reset based on the halting of the processor function.

### PRIORITY

This US non-provisional utility patent application is co-pending with, claims priority to, and incorporates by reference in its entirety US non-provisional utility patent application entitled “LOCATION DETERMINATION SYSTEM AND METHOD USING ARRAY ELEMENTS FOR LOCATION TRACKING” Ser. No. ______, filed herewith, and claims priority to and incorporates by reference in its entirety US non-provisional application entitled “DYNAMIC WIRELESS NETWORKS AND INTERACTIVE WIRELESS INFORMATION COMMUNICATION AND DELIVERY SYSTEMS FOR CALCULATING DISTANCE TO AN OBJECT”, Ser. No. 13/310,761 filed on Dec. 4, 2011, and claims priority to and incorporates by reference in its entirety co-pending U.S. Utility patent application Ser. No. 13/010,437 filed on Jan. 20, 2011.

### BACKGROUND OF THE DISCLOSURE

1. Field of the Disclosure

The present disclosure relates generally to the field of communications systems that provide communications and location information. More particularly, the present disclosure relates in one embodiment to a system for information of a wireless Internet unit such as a Wi-Fi unit that provided wireless communication or data transfer and/or wireless location and tracking systems and wireless communication system (WCS).

2. Description of Related Technology

In conventional communication and location systems, there is a need for monitoring processes and functionality and to correct or adjust one or more settings. One conventional system discloses a real-time system to monitor configuration data and generate a warning message when there is a detected difference between the real-time settings and the preset configuration device settings. Another conventional system discloses a method for varying functionality modes of computer devices and a power reset module and an automatic shut-off module of a target device to momentarily disrupt power to the automatic shut-off module at a determined interval and automatically restore power.

In yet another example, conventional system discloses a radio access technology (RAT) monitoring system that maintains a first RAT while scanning or accessing a second RAT. In yet another example, system discloses an arbitration process for turning on and off first and second wireless signal while decreasing the occurrence of transmission disconnection. Another Wi-Fi reset circuit discloses a capacitance charge and discharge circuit to monitor presence or absence of data. Still other conventional systems disclose an auto-reset user interface element when an alert automatically resets, component failures report when the failure may cause disruption of bus line activity, or provides a sleep function that turns off device clock upon receipt of a first and a second signal. Yet others disclose a router congestion scheme to combine connections or adjust communication parameters based on type of losses.

In summary, the prior art provides a user limited flexibility and monitoring of wireless devices functionality and providing an automatic initiation or revival of settings thereof. In addition, the prior art provides limited flexibility for multiple wireless devices monitoring and providing initiation or revival of settings thereof. Furthermore, the prior art has limited capability for determining or detecting partial, substantial, or even full loss of a wireless device or unit functionality.

Thus, what is needed are apparatus and methods for wireless systems or wireless location devices that provide advantages over conventional systems. These advantages would include, inter alia, detecting of partial, halting, or full non-functionality of one or more wireless communication or location detection units, resetting of one or more wireless communication or location detection units in accordance with monitored information, and ability to reset multiple or one or more wireless units that have been detected with a partial or substantial loss of functionality.

### SUMMARY

A wireless network reset system is disclosed. In one aspect, system couples or connects to power supply line. A microcontroller software module is configured to sense a signal from Wi-Fi module that indicates a halting of processor function, and reset module to execute a reset based on halting of processor function. In one embodiment, sense a signal includes examination of the signal of processor from Wi-Fi module. In one variant, sense a signal includes examination of the signal of one or more processors from one or more Wi-Fi devices capable of or coupled by wireless connectivity to Wi-Fi module.

The system may include switching device to supply Wi-Fi module with a reset voltage responsive to an output from the microcontroller software module upon detection of the halting of the processor function measured on signal monitoring line. In one variant, the reset module includes a switching device that cycles off and on power supply line coupled or connected to Wi-Fi module that has one or more wireless communication devices that have processor that is stuck or has stopped functionality in one or more processing areas. In yet another embodiment, signal includes signal from a signal monitoring line and processor executes commands to detect presence of wireless communication devices in designated consumer retail area or location.

In another aspect, wireless network reset apparatus is connected or coupled to power supply line. The apparatus includes comparator(s) to monitor processor signal of Wi-Fi module and detect a processor signal of Wi-Fi module being one associated with halting of one or more processor functions. The apparatus may further include switching device to supply Wi-Fi module with reset voltage responsive to output from Wi-Fi module that indicates halting of the one or more processor functions measured on signal monitoring line of Wi-Fi module. The apparatus may further include reset module that includes switching device that cycles off and on the power supply line coupled to at least one of Wi-Fi module or one or more wireless communication devices, wherein one or more wireless communication devices are capable of coupling to at least one Wi-Fi module.

In another embodiment, reset module includes switching device that cycles off and on power supply line connected and/or coupled to one or more devices that have processor that is stuck in current state or has stopped functionality. In addition, level shifting circuit is further included to compare output signal associated with state check of processor signal of Wi-Fi module to form reset signal to restart one or more processors of Wi-Fi module or one or more processors of one or more wireless communication devices capable of connection or coupling to Wi-Fi module. In one variant, level shifting circuit is included to compare output signal associated with state check of the processor signal from Wi-Fi module to form reset signal to reinitiate one or more processors of wireless devices capable of connection or coupling to Wi-Fi module or processor of Wi-Fi module.

In yet another aspect, a method is disclosed to reset wireless network reset system. The method includes sensing by microcontroller software module a signal from Wi-Fi module that indicates halting of processor function and executing reset command by reset module responsive to the halting of the processor function. The method may further include the step of sensing a signal includes examining signal of processor of Wi-Fi module. The method may further include the step of sensing a signal includes examining signal from one or more Wi-Fi devices capable of wireless connectivity to or connected to Wi-Fi module. The method may further include the step of executing reset command that includes supplying by switching device Wi-Fi module with reset voltage responsive to output from microcontroller software module upon detection of halting of the processor function of Wi-Fi module as measured on signal monitoring line.

These and other embodiments, aspects, advantages, and features of the present disclosure will be set forth in part in the description which follows, and in part will become apparent to those skilled in the art by reference to the following description of the disclosure and referenced drawings or by practice of the disclosure. The aspects, advantages, and features of the disclosure are realized and attained by means of the instrumentalities, procedures, and combinations particularly pointed out in the appended claims.

### BRIEF DESCRIPTION OF THE DRAWINGS

FIG. 1 is a block diagram of a reset circuit illustrating principles of the present disclosure;

FIG. 2 is a circuit diagram of a reset circuit using a microcontroller that is an example of the reset circuit in accordance with the present disclosure;

FIG. 3 is a circuit diagram of a reset circuit using comparators and an external power supply switch that is another example of the reset circuit in accordance with the present disclosure;

FIG. 4 is a circuit diagram of a reset circuit using comparators and an internal Wi-Fi module switch that is another example of the reset circuit in accordance with the present disclosure;

FIG. 5 is a system block diagram illustrating usage of the reset circuits of FIGS. 1-4 including smart phones and objects in accordance with the present disclosure;

FIG. 6 is a system block diagram illustrating usage of the reset circuits of FIGS. 1-4 including smart phones and objects associated data tags in accordance with the present disclosure; and

FIG. 7 is a method illustrating usage of the reset circuits of FIGS. 1-6 in accordance with the present disclosure.

### DETAILED DESCRIPTION

Reference is now made to the drawings wherein like numerals refer to like parts throughout.

As used herein, the term “wireless” refers to wireless communication to a device or between multiple devices. Wireless devices may be anchored to a location and/or hardwired to a power system, depending on the needs of the business, venue, event or museum. In one embodiment, wireless devices may be enabled to connect to Internet, but do not need to transfer data to and from Internet in order to communicate within the wireless information communication and delivery system.

As used herein, the term “Smart Phone” or “smart phone” refers to a wireless communication device, that includes, but not is limited to, an integrated circuit (IC), chip set, chip, system-on-a-chip including low noise amplifier, power amplifier, Application Specific Integrated Circuit (ASIC), digital integrated circuits, a transceiver, receiver, or transmitter, dynamic, static or non-transitory memory device(s), one or more computer processor(s) to process received and transmitted signals, for example, to and from the Internet, other wireless devices, and to provide communication within the wireless information communication and delivery system including send, broadcast, and receive information, signal data, location data, RSSI (Relative Signal Strength Indicator), one or more indications of signal strength to data tags from one or more information repositories, a bus line, an antenna to transmit and receive signals, and power supply such as a rechargeable battery or power storage unit. The chip or IC may be constructed (“fabricated”) on a “die” cut from, for example, a Silicon, Sapphire, Indium Phosphide, or Gallium Arsenide wafer. The IC may be, for example, analogue or digital on a chip or hybrid combination thereof. Furthermore, digital integrated circuits may contain anything from one to thousands or millions of signal invertors, and logic gates, e.g., “and”, “or”, “nand” and “nor gates”, flipflops, multiplexors, etc., on a square area that occupies only a few millimeters. The small size of, for instance, IC's allows these circuits to provide high speed operation, low power dissipation, and reduced manufacturing cost compared with more complicated board-level integration.

As used herein, the terms “location information” refer without limitation to any set or partial set of integer, real and/or complex location data or information such as longitudinal, latitudinal, and elevational positional coordinates or relative location coordinates to one or more objects, Wi-Fi networks, and wireless communication devices.

As used herein, the terms “wireless data transfer,” “wireless tracking and location system,” “positioning system” and “wireless positioning system” refer without limitation to any wireless system that transfers data or communicates or broadcasts a message, which communication may include location coordinates or advertisements using one or more devices, e.g., wireless communication devices.

As used herein, the terms “module” or “modules” refer without limitation to any software, software program(s), firmware, or actual hardware or combination thereof that has been added on, downloaded, updated, transferred or originally part of a larger computation or transceiver system that assists in or provides computational ability including, but not limited to, logic functionality to assist in or provide communication broadcasts of commands or messages, which communication may include location coordinates or advertisements between, among, or to one or more devices, e.g., wireless communication devices.

### Overview

In one salient aspect, the present disclosure discloses apparatus and method of calculating, inter alia, determining functionality of a wireless communication device or wireless communication network. In particular, a wireless reset circuit. The wireless reset circuit senses halting of functionality of a wireless communication device. A reset circuit provides a reset signal to reset the wireless communication device.

Broadly, the present disclosure generally provides a system and method for restarting wireless communication devices that have halted, at least partially, functionality. The system produced according to the present disclosure may find beneficial use for restarting stopped (halted) wireless communication devices, such as smart phones, Wi-Fi modules, Wi-Fi networks, communication servers, data tags, or the like. The system may also be useful for resetting other communication devices. Additionally, objects, such as vehicles, goods, and merchandise may be located and tracked after Wi-Fi reset using the system produced by the present disclosure. Although the following discussion may use halted processor wireless communication devices as an exemplary demonstration, it is to be understood that this discussion is not limiting and that the present disclosure may be used in other suitable applications.

### Exemplary Embodiments of the Present Disclosure

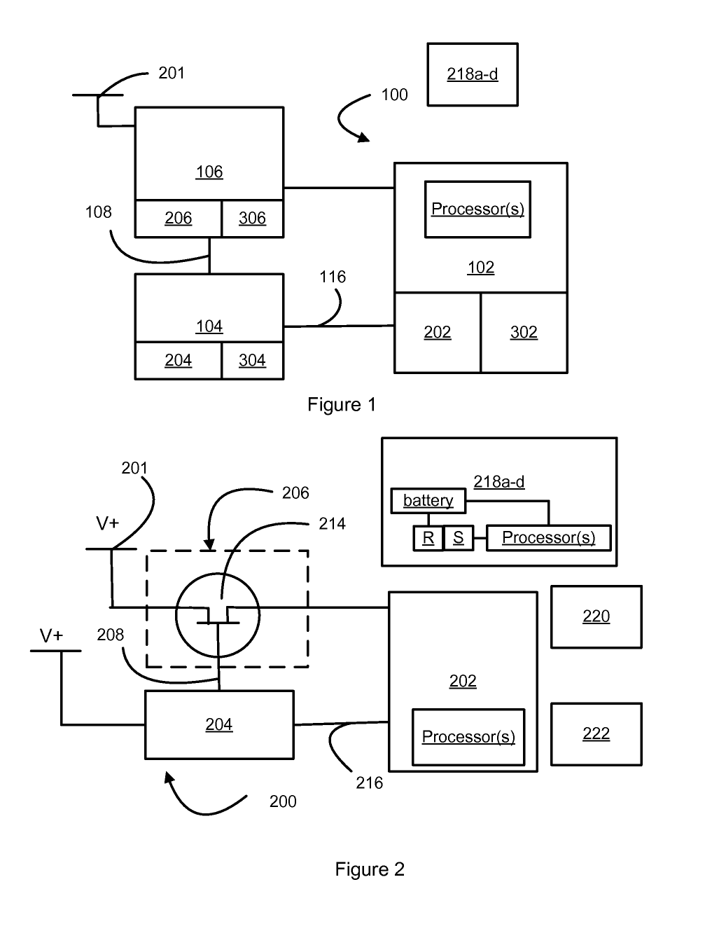

Referring now to FIGS. 1-7, exemplary embodiments of the resetting and monitoring system of the present disclosure are described in detail. It will be appreciated that while described primarily in the context of resetting wireless communication devices, at least portions of the apparatus and methods described herein may be used in other applications, such as for example and without limitation, control systems that monitor components such as transducers, sensors, and electrical and/or optical components within an assembly line process.

Moreover, it will be recognized that the present disclosure may find utility beyond purely communication and monitoring concerns. For example, the Wi-Fi reset system and apparatus described subsequently herein may conceivably be utilized to improve other applications; e.g., increasing functionality and electrical properties of circuits utilized to improve computational efficiency and increase accuracy of calculated quantities. The calculated quantities may include improvement of quality control of objects traveling through an assembly line process for determining which portions of the process are running efficiently and which portions may require process improvements or modifications, e.g., system restart. Other functions might include module assembly, maintaining system parameters, and system reboot monitoring and initiation (e.g., for purposes of providing transceivers that provide multiple methods and user choices for displaying electrical properties and measurement parameters during testing and/or operations before, during or after wireless module completion, and so forth). Myriad of other functions will be recognized by those of ordinary skill in the art given the present disclosure.

Referring to embodiment illustrated in FIG. 1, wireless network system 100 includes a wireless communication device 102, sense circuit 104, and reset circuit 106. In one embodiment, sense and reset circuits 104, 106 functionality may implemented as firmware, e.g., installed or implemented as part of original or add-on software module, or actual electronic hardware or in some instances a combination thereof. Wireless communication device 102, e.g., Wi-Fi module, wireless network module, wireless communication device, ultra-sound controller, ultra-sound module, personnel communication device, smart phone, or the like, couples or connects to sense circuit 104, for instance, through signal monitoring line 116 to determine status of one or more software programs having executable code that is being executed or will be executed upon an appropriate command. In one example, status of one or more software programs is indicated by examination of, e.g., sense a signal, of a processor from wireless communication device 102.

In another example, status of one or more software programs is indicated by examination of the signal of one or more processors from one or more wireless communication devices, such as wireless communication device 102 including one or more Wi-Fi devices, capable of or coupled by wireless connectivity to wireless communication device 218a-d. In operation, in one embodiment, signal monitoring line 116 monitors status of wireless communication device 102.

Under certain circumstances, wireless communication device 102 suffers from halting of internal program execution. For instance, upon high amount of Wi-Fi traffic, wireless communication device 102 may switch to one of many reduced performance modes. In yet another instance, when one or more software programs stop execution, a wireless communication device 102 may switch to a reduced performance mode or even be disabled rendering the wireless communication device 102 without capability to provide communication. Upon detection by sense circuit 104 of a loss of partial, substantial, significant, or all processor functionality for one or more executed software programs, reset circuit 106 signals wireless communication device 102 to perform reset function to begin restart or restore execution of wireless communication device 102. FIGS. 2-4 include examples of sense circuit 102 and reset circuit 104 that perform reset function.

Referring to FIG. 2, wireless network reset system 200 couples or connects to a power supply line 201. A microcontroller software module 204, e.g. PIC microcontroller, is configured to sense signal from Wi-Fi module 202 that indicates a halting of one or more processor(s) functionality. Reset module 206 executes reset based on halting of processor function. In one variant, switching device 214 supplies Wi-Fi module 202 with reset voltage responsive to output from microcontroller software module 204, e.g., internal firmware, upon detection of halting of processor function measured on signal monitoring line 216, for instance, connected or coupled, for instance, to one of input/output or general purpose input/output (GPIO), e.g., GPIO1, processor lines. Continuing with this variant, the signal monitoring line 216 may have a signal including a stream of digital signals and/or other type of signal. Microcontroller software module 204 causes output, such as second GPIO 208, e.g., GPIO 2, line to change. The signal on the GPIO 2 line 200 can be used to switching device 214, e.g., transistor, magnetic relay switch, to switch and cycle power supply line of Wi-Fi module 202 off and then on again. This change or switching of power causes Wi-Fi module 202 to be reset and begin its internal program execution again. In one example, upon the signal monitoring line 216 voltage is high (e.g., +3.3 V), module power supply line 201 voltage is high (e.g., +3.3 V), then Wi-Fi module 202 is “on” state (operational). On the other hand, upon signal monitoring line 216 voltage is low (e.g., 0 V), module power supply line 201 voltage is low (e.g., 0 V), then Wi-Fi module 202 is “off” state (non-operational).

In one embodiment, reset module 206 includes switching device 214, e.g., transistor, that cycles “off” and “on” power supply line 201 coupled or connected to Wi-Fi module 208 that has one or more wireless communication devices 218a-d that have processor stuck or has stopped functionality in one or more processing or software functionality areas. Referring to wireless communication devices 218 a-d, upon S sense circuit, e.g., which may be a firmware module installed or added on to existing software or actual electrical hardware or combination thereof, receiving signals indicating loss of functionality of processor, R reset circuit, which may be firmware or hardware, communicates reset that cycles off and on battery to restart processors within the one or more wireless communication devices 218 a-d. As such, wireless communication devices 218 a-d reset is similar as functionality as embodiment 100. In one variant, signal includes signal from signal monitoring line 216 and processor executes commands to detect presence of wireless communication devices 218a-d in designated consumer retail area 220 or location 222. In addition, signal includes examination of the signal of processor from Wi-Fi module 202. In one variant, sense a signal includes examination of the signal of one or more processors from one or more Wi-Fi devices, e.g., wireless communication devices 218a-d, capable of or coupled by wireless connectivity to Wi-Fi module 202.

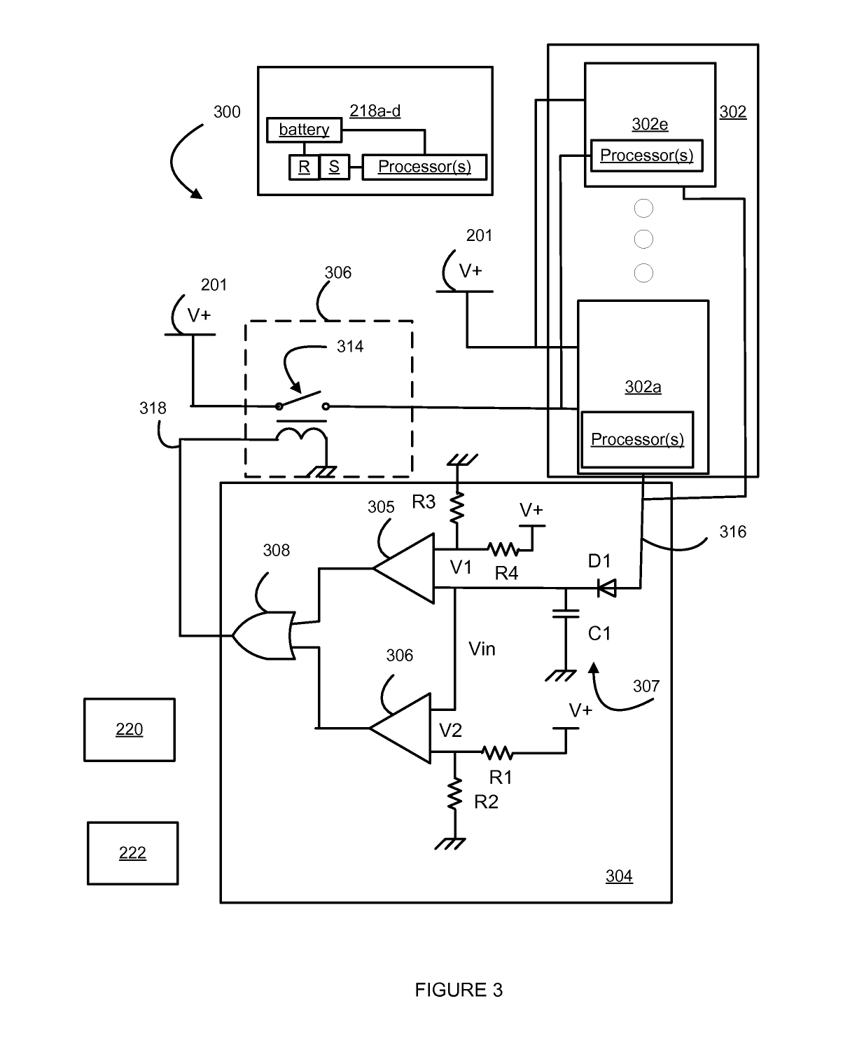

Referring to FIG. 3, wireless network reset apparatus 300 is disclosed. Wireless network reset apparatus connects or couples to power supply line 201. Apparatus 300 includes comparators 305, 306 to monitor processor signal of Wi-Fi module 302 and detect processor(s) signal of Wi-Fi module 302 being one associated with halting of one or more processor functions. In one example, signal monitoring line 316 has a monitored signal that is filtered by a signal conditioning circuit 307. In one example, signal conditioning circuit 307 includes series diode D1 with shunt capacitor C1. In this example, series diode D1 rectifies the incoming signal and provides isolation between Wi-Fi module 302 and comparators 305, 306. Shunt capacitor C1 serves to integrate output from series diode D1.

Sensing circuit 304 includes dual comparators 305, 306, e.g., nand gates, that compare level-shifted supply voltage levels, e.g., from voltage dividers R3, R4, and R1, R2 respectively, and outputs feed to an “or” function logic gate 308 to generate reset signal on reset signal line 318 that is feed to reset circuit 306, e.g., switching device 314. Comparator 305 (comparator 1) causes output to go high if its integrated voltage is above V1. Comparator 306 (comparator 2) causes output to go high if its input Vin is below V2. If Vin is below V1 and above V2, then the outputs of comparator 1 and comparator 2 are zero. Output of “or” gate 308 goes high if either comparator 1 or comparator 2 goes high. As such, reset signal line will go high if VIN is below or above preset thresholds that are set by the resistive divider network. Reset line 308 controls switching device 314, e.g., magnetic relay switch, which causes Wi-Fi module 302, e.g., Wi-Fi modules 302a-g, to be turned off and back on again to restart its program execution.

In one example, switching device 314, e.g., single pole, single throw switch, supplies Wi-Fi module 302 with reset voltage 312 responsive to output of “or” gate from the within Wi-Fi module 208 that indicates halting of one or more processor(s) functions measured on signal monitoring line 316 of one or more Wi-Fi modules 302a-g. As such, switching device 306 interrupts power supply line 201 to restart one or more Wi-Fi modules 302a-g restarting or initiating program executions.

In one embodiment, reset module 306 includes switching device 314, e.g., magnetically actuated relay switch, single pole, single throw switch, or the like, that cycles “off” and “on” power supply line 201 coupled or connected to one or more Wi-Fi modules 302a-g or one or more wireless communication devices 218a-d, wherein the one or more wireless communication devices 218a-d are capable of coupling to one or more Wi-Fi modules 302a-g. In one variant, reset module 306 includes switching device 314 that cycles “off” and “on” power supply line 201 connected or coupled to one or more wireless communication devices 218a-d that have processor stuck in current state, e.g., “on” state, or has stopped functionality, e.g., “off” state.

In one variant, level shifting circuit 307 compares output signal associated with state check of processor signal of Wi-Fi module 302 reset signal to restart one or more processors of Wi-Fi module 302 or one or more processors of one or more wireless communication devices 218a-d capable of connection or coupling to Wi-Fi module 302. In one variant, level shifting circuit 307 that compares output signal associated with state check of processor signal from Wi-Fi module 208 to form reset signal to begin restart or reinitiate, e.g., reset functionality of, one or more processors of one or more wireless devices 218a-d capable of connection or coupling to Wi-Fi modules 302a-g or processor of Wi-Fi modules 302a-g.

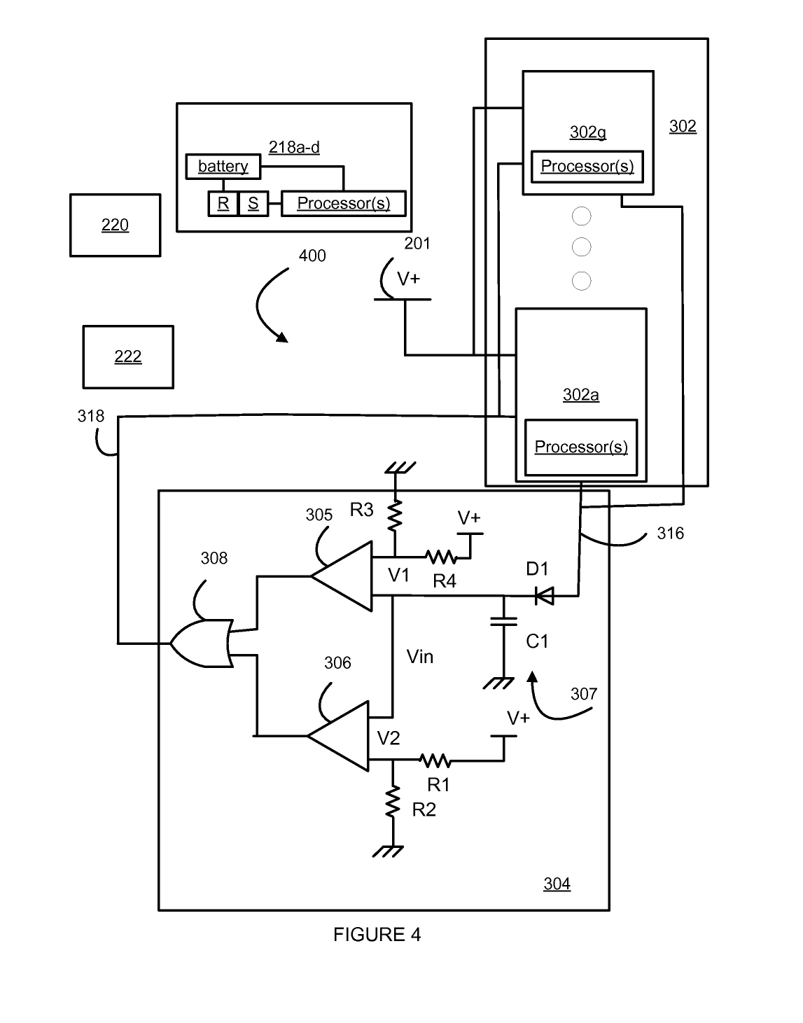

Referring to FIG. 4, wireless network reset apparatus 400 is disclosed. In this embodiment, it is the same as FIG. 3 except Wi-Fi modules 302a-g has a reset line. As such, the reset line can be connected to the output of the “or” gate 307 without need of reset module 306, e.g., switching device 314.

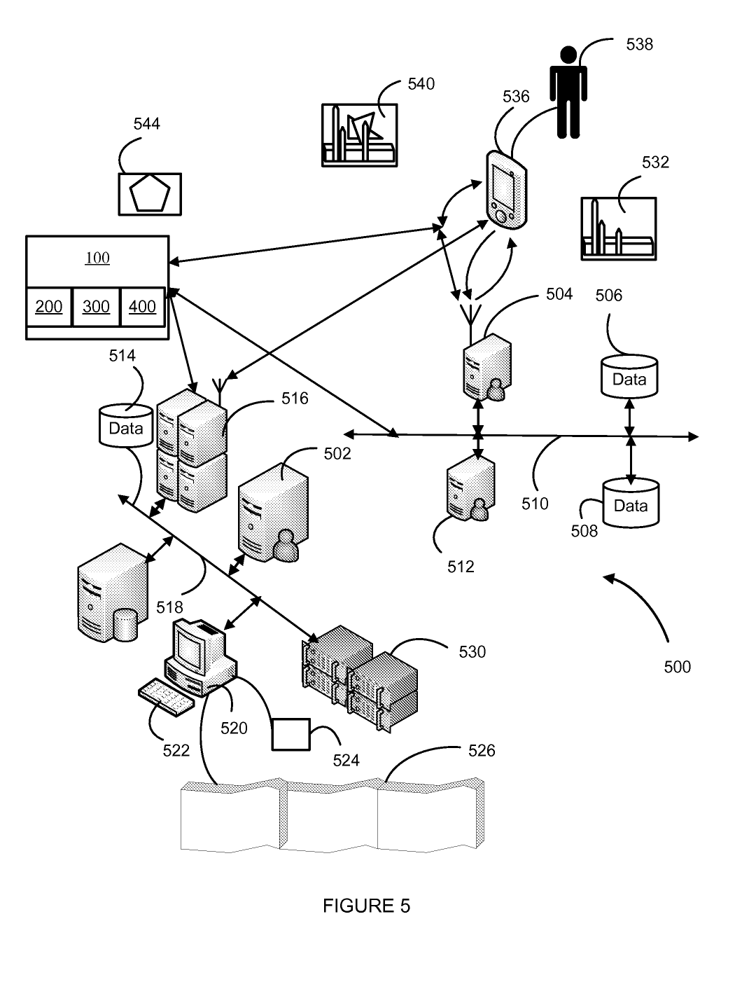

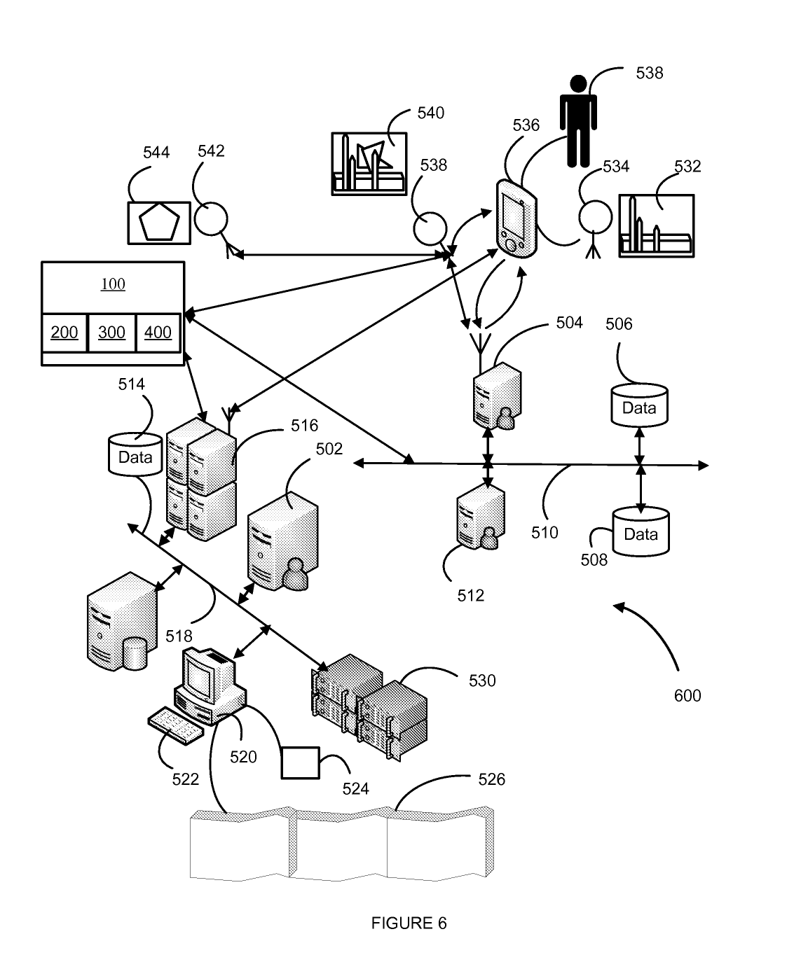

Referring to FIGS. 5 and 6, systems 500 and 600 disclose utilization of Wi-Fi reset systems 100, 200, 300, or 400 that communicates with one or more wireless communication devices, e.g., communications server 516, smart phone 536 (Smart Phone 1 and Smart Phone 2), and communications server 504.

In system 500, Smart phone 536, e.g., Smart Phone 1 or Smart Phone 2, measures relative signal strength of a wireless enabled device broadcasting a signal within a distance range of objects 544, 540, and 532, for instance, as illustrated in FIGS. 1-9, Table 1, and associated text from incorporated by reference in its entirety and claim priority to pending US utility patent application entitled “DYNAMIC WIRELESS NETWORKS AND INTERACTIVE WIRELESS INFORMATION COMMUNICATION AND DELIVERY SYSTEMS FOR CALCULATING DISTANCE TO AN OBJECT”, Ser. No. 13/310,761 that was filed on Dec. 4, 2011.

In system 600, smart phone 536, e.g., Smart Phone 1 or Smart Phone 2, measures relative signal strength of a wireless enabled device broadcasting a signal within a distance range of objects referenced by data tags 542, 538, and 534, for instance, as illustrated in FIGS. 1-9, Table 1, and associated text incorporated by reference in its entirety and claim priority to pending US utility patent application entitled “DYNAMIC WIRELESS NETWORKS AND INTERACTIVE WIRELESS INFORMATION COMMUNICATION AND DELIVERY SYSTEMS FOR CALCULATING DISTANCE TO AN OBJECT”, Ser. No. 13/310,761 that was filed on Dec. 4, 2011.

Upon detection by sense circuit 104 of halting of processor function, e.g., partial, substantial, or total, of one or more Wi-Fi modules, e.g., Wi-Fi modules 102, 202, 302a-g, smart phone 536, communications servers 516, 512, 504, reset module, e.g., reset module 106, 206, 306, executes reset based on halting of processor function. As such, sense circuit 104 and reset module 106 reestablish upon halting of wireless connectivity of one or more Wi-Fi modules 102, 202, 302a-g and/or wireless communication devices 218a-d.

Systems 500 and 600 communicate, for instance, using communications server 516 by wired bus 518 or wireless means, such as by Wi-Fi connectivity. In one variant, systems 500 and 600 may access private and public databases, though communications server 504, 512 having wireless capability, e.g., Wi-Fi connectivity to access, for instance, information repository 506, 508 coupled to bus 510 and extracts information, e.g., RSSI, from a nearby smart phone 536, for instance, Smart Phone 1 and Smart Phone 2 illustrated in FIGS. 1-9 and associated text or in Table I incorporated by reference in its entirety and claim priority to pending US utility patent application entitled “DYNAMIC WIRELESS NETWORKS AND INTERACTIVE WIRELESS INFORMATION COMMUNICATION AND DELIVERY SYSTEMS FOR CALCULATING DISTANCE TO AN OBJECT”, Ser. No. 13/310,761 that was filed on Dec. 4, 2011.

Systems 500 and 600 further includes data storage hardware device 514 capable of storage of user data, e.g., preferences, interests, “perspectives” in the information system, relative coordinates of smart phone 536 and/or user 538 using the smart phone 536 to an object, e.g., painting 544, 540, 532, (as illustrated in FIG. 5) or Wi-Fi device or data tags 542, 538, 534 (as illustrated in FIG. 6) associated with or closest to the object. For example, a particular item or location, e.g., as well as other information, for instance, relative location or distance from one or more of data tags 542, 538, 534 that are referenced, for instance, to an object, such as object 544, 540, 532 respectively, or other components disclosed in FIGS. 1-9 and Table I incorporated by reference in its entirety and claim priority to pending US utility patent application entitled “DYNAMIC WIRELESS NETWORKS AND INTERACTIVE WIRELESS INFORMATION COMMUNICATION AND DELIVERY SYSTEMS FOR CALCULATING DISTANCE TO AN OBJECT”, Ser. No. 13/310,761 that was filed on Dec. 4, 2011.

Application server 502 stores executable software program code, for instance, RSSI signal strength calculation or User Datagram Protocol (UDP) algorithms in a semi-transitory or non-transitory software media capable of transferability using communications server 516 to transmit wired or wirelessly from processor unit 524, for example, communicatively coupled to computer 520 that has a keyboard 502 to allow, for instance, user 538 to provide remote inputs or direct inputs (if user is within range of keyboard 522). Continuing with this embodiment, systems 500, 600 may store executable software program code in application server 502 in one or more tangible forms, for example, in a communicatively coupled to memory 526 (which may be ram, flash, or flash drive) or persistent storage 530 such as a hard drive or rewritable hard-disk external (that may be fixed or removable) communicatively coupled to computer 520, for instance, through bus line, e.g., bus line 518.

In one embodiment, communications server 516 transmits wirelessly to another network, e.g., radio towers, cell-phone towers, communication satellites, or the like, to access files stored in databases 506, 508 (e.g., private databases). In one variant, the databases 506, 508 are one or more information repositories accessible through communication servers 504, 512 and coupled wirelessly, e.g., using data tags 542, 538, or 534 or smart phone 536 or wired, for instance, to bus line, e.g., bus lines 510, 518. In another variant, communications server 504 transmits wirelessly to another network, e.g., radio towers, cell-phone towers, communication satellites, or the like to access files or documents stored in database 514, for instance, accessible through bus line, e.g., bus line 518. In yet another example, systems 500 and 600 may be stored in memory in a consumer apparatus or smart phone 536 (e.g., a hand-held computer with plug in serial, parallel, or usb adaptor compatibility) through bus line 510, 518 or wirelessly coupled using a local network, e.g., wireless servers 516, 504, 512 or through cell phone towers, communication satellites to access, for instance, one or more databases 514, 506, 508 for accessing sets of consumer data processing by systems 500 or 600.

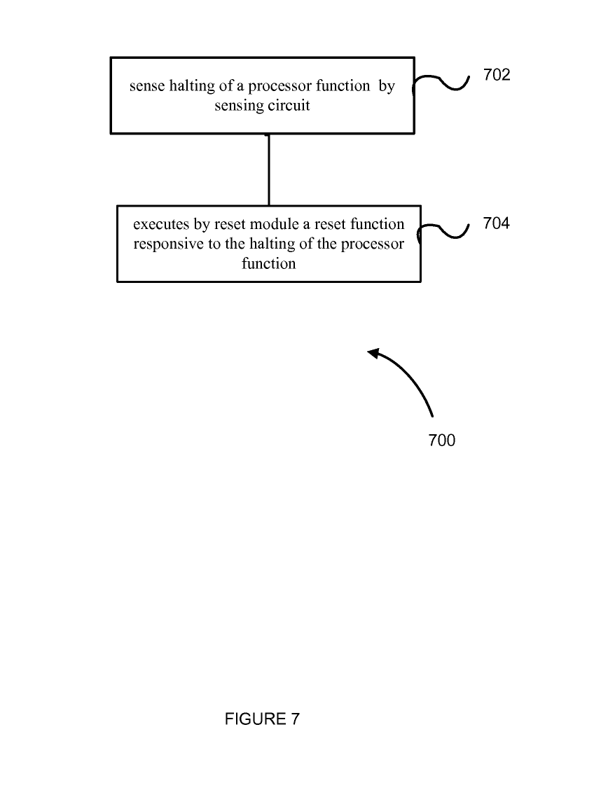

Referring to FIG. 7 is a logical flow diagram 700 illustrating one exemplary embodiment of method 700 to reset a wireless network in accordance with the present disclosure. This method is based on components, apparatus, or systems previously discussed in FIGS. 1-6. Sensing circuit indicates a halting of a processor function (step 702). In one variant, microcontroller software module senses a signal from Wi-Fi module that indicates a halting of a processor function. A reset module responsive to the halting of the processor function executes a reset command (step 704). In one variant, the step of sensing a signal may include examining the signal of a processor of Wi-Fi module and/or one or more wireless communication devices 218a-d capable of connection or coupling to one or more Wi-Fi modules, e.g., Wi-Fi modules 102, 202, and 302a-g. In yet another variant, the step of sensing a signal includes examining the signal from one or more Wi-Fi devices capable of wireless connectivity to or connected to the Wi-Fi module. In yet another embodiment, the step of executing a reset command includes supplying by a switching device Wi-Fi module with a reset voltage responsive to an output from the microcontroller software module upon detection of the halting of the processor function of Wi-Fi module as measured on a signal monitoring line.

It is noted that many variations of the methods described above may be utilized consistent with the present disclosure. Specifically, certain steps are optional and may be performed or deleted as desired. Similarly, other steps (such as additional data sampling, processing, filtration, calibration, or mathematical analysis for example) may be added to the foregoing embodiments. Additionally, the order of performance of certain steps may be permuted, or performed in parallel (or series) if desired. Hence, the foregoing embodiments are merely illustrative of the broader methods of the disclosure disclosed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the spirit of the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

We claim:

1. A wireless network reset system coupled or connected to a power supply line, the system comprising:
a microcontroller software module configured to sense a signal from a Wi-Fi module that indicates a halting of a processor function; and
a reset module to execute a reset based on the halting of the processor function.

2. The system of claim 1, wherein sense a signal includes examination of the signal of a processor from the Wi-Fi module.

3. The system of claim 1, wherein sense a signal includes examination of the signal of one or more processors from one or more Wi-Fi devices capable of or coupled by wireless connectivity to the Wi-Fi module.

4. The system of claim 1, further comprising a switching device to supply the Wi-Fi module with a reset voltage responsive to an output from the microcontroller software module upon detection of the halting of the processor function measured on a signal monitoring line.

5. The system of claim 3, wherein the reset module includes a switching device that cycles off and on the power supply line coupled or connected to the Wi-Fi module that has one or more wireless communication devices that have a processor that is stuck or has stopped functionality in one or more processing areas.

6. The system of claim 2, wherein a signal includes a signal from a signal monitoring line;
and wherein the processor executes commands to detect presence of wireless communication devices in a designated consumer retail area or location.

7. A wireless network reset apparatus connected to a power supply line, the apparatus comprising:
a comparator to monitor a processor signal of a Wi-Fi network and detect a processor signal of the Wi-Fi module being one associated with a halting of one or more processor functions.

8. The apparatus of claim 7, further comprising a switching device to supply the Wi-Fi network with a reset voltage responsive to an output from the Wi-Fi module that indicates halting of the one or more processor functions measured on a signal monitoring line of the Wi-Fi module.

9. The apparatus of claim 7, further comprising a reset module that includes a switching device to switch and to cycle off and on the power supply line coupled to at least one of the Wi-Fi module or one or more wireless communication devices, wherein the one or more wireless communication devices are capable of coupling to the at least one Wi-Fi module.

10. The apparatus of claim 7, further comprising a reset module includes a switching device that cycles off and on a power supply line or battery coupled or connected to one or more devices that have a processor that is stuck in a current state or has stopped functionality.

11. The apparatus of claim 7, further comprising a level shifting circuit that compares an output signal associated with a state check of the processor signal of the Wi-Fi module to form a reset signal to restart one or more processors of the Wi-Fi module or one or more processors of one or more wireless communication devices capable of connection or coupling to the Wi-Fi module.

12. The apparatus of claim 6, further comprising a level shifting circuit that compares an output signal associated with a state check of the processor signal from the Wi-Fi module to form a reset signal to reinitiate one or more processors of wireless devices capable of connection or coupling to the Wi-Fi module or a processor of the Wi-Fi module.

13. A method to reset a wireless network, the method comprising:
sensing by a microcontroller software module a signal from a Wi-Fi module that indicates a halting of a processor function; and
executing a reset command by a reset module responsive to the halting of the processor function.

14. The method of claim 13, wherein the step of sensing by a microcontroller software module a signal includes examining the signal of a processor of the Wi-Fi module.

15. The method of claim 14, wherein the step of sensing by the microprocessor software module a signal includes examining the signal from one or more Wi-Fi devices capable of wireless connectivity to or connected to the Wi-Fi module.

16. The method of claim 13, wherein the step of executing a reset command includes supplying by a switching device the Wi-Fi module with a reset voltage responsive to an output from the microcontroller software module upon detection of the halting of the processor function of the Wi-Fi module as measured on a signal monitoring line.
